(19) United States
(12) Patent Application Publication
(10) Pub. No.: US 2026/0134672 A1
(43) Pub. Date: May 14, 2026

(54) TOWARDS ZERO-SHOT ANOMALY DETECTION AND REASONING WITH MULTIMODAL LARGE LANGUAGE MODELS

(71) Applicant: Honda Motor Co., Ltd., Tokyo (JP)

(72) Inventors: Jiacong XU, Mountain View, CA (US); Shao-Yuan LO, Milpitas, CA (US); Isht DWIVEDI, Mountain View, CA (US)

(21) Appl. No.: 19/201,837

(22) Filed: May 7, 2025

Related U.S. Application Data
(60) Provisional application No. 63/720,095, filed on Nov. 13, 2024.

(51) Int. Cl. G06V 10/82; G06V 10/40; G06V 10/77; G06V 10/774

(52) U.S. Cl. CPC G06V 10/82; G06V 10/40; G06V 10/7715; G06V 10/774

(57) ABSTRACT

According to one aspect, towards zero-shot anomaly detection and reasoning with multimodal large language models (MLLMs) may include generating a set of one or more visual tokens based on an input image, generating a significance map for the set of visual tokens based on the set of visual tokens and look-twice feature matching (LTFM), and identifying one or more anomalous visual tokens associated with the input image based on the set of one or more visual tokens associated with the input image and the significance map.

### CROSS REFERENCE TO RELATED APPLICATIONS

This application claims the benefit of U.S. Provisional Patent Application, Ser. No. 63/720,095 (Attorney Docket No. HRA-57004) entitled “TOWARDS ZERO-SHOT ANOMALY DETECTION AND REASONING WITH MULTIMODAL LARGE LANGUAGE MODELS”, filed on Nov. 13, 2024; the entirety of the above-noted application(s) is incorporated by reference herein.

### BACKGROUND

Multimodal Large Language Models (MLLMs) are artificial intelligence (AI) models that may understand and create content in multiple forms, like text, images, and audio. MLLMs may combine the reasoning abilities of Large Language Models (LLMs) with the ability to process and output multimodal information. Training an MLLM from scratch demands extensive data and computational resources to align the visual and textual embedding spaces and develop robust instruction-following capabilities. Often, pretrained MLLMs function as generalists, possessing a broad knowledge base but underperforming in specialized domains.

### BRIEF DESCRIPTION

According to one aspect, a system for towards zero-shot anomaly detection and reasoning with multimodal large language models (MLLMs) may include a memory and a processor. The memory may store one or more instructions. The processor may execute one or more of the instructions stored on the memory to perform one or more acts, actions, and/or steps. The processor may perform generating a set of one or more visual tokens based on an input image, generating a significance map for the set of visual tokens based on the set of visual tokens and look-twice feature matching (LTFM), and identifying one or more anomalous visual tokens associated with the input image based on the set of one or more visual tokens associated with the input image and the significance map.

The identifying one or more anomalous visual tokens may be based on a large language model (LLM). The identifying one or more anomalous visual tokens may include generating a first input for the LLM based on a projector and one or more of the anomalous visual tokens. The identifying one or more anomalous visual tokens may include generating a second input for the LLM based on a tokenizer and a query. The identifying one or more of the anomalous visual tokens may include element-wise multiplication of a visual token from the set of visual tokens and the significance map. The identifying one or more of the anomalous visual tokens may include applying spatial average pooling.

The generating the set of one or more of the visual tokens may be based on a visual encoder and the input image. The LTFM may include merging a visual token from the set of visual tokens with a first learnable, positive embedding. The LTFM may include merging a visual token from the set of visual tokens with a second learnable, negative embedding. The LTFM may include generating a description by passing the merged visual token through a multi-layer perceptron (MLP).

According to one aspect, a computer-implemented method for towards zero-shot anomaly detection and reasoning with multimodal large language models (MLLMs) may include generating a set of one or more visual tokens based on an input image, generating a significance map for the set of visual tokens based on the set of visual tokens and look-twice feature matching (LTFM), and identifying one or more anomalous visual tokens associated with the input image based on the set of one or more visual tokens associated with the input image and the significance map.

The identifying one or more anomalous visual tokens may be based on a large language model (LLM). The identifying one or more anomalous visual tokens may include generating a first input for the LLM based on a projector and one or more of the anomalous visual tokens. The identifying one or more anomalous visual tokens may include generating a second input for the LLM based on a tokenizer and a query. The generating the set of one or more of the visual tokens may be based on a visual encoder and the input image.

According to one aspect, a system for towards zero-shot anomaly detection and reasoning with multimodal large language models (MLLMs) may include a memory and a processor. The memory may store one or more instructions. The processor may execute one or more of the instructions stored on the memory to perform one or more acts, actions, and/or steps. The processor may perform generating a set of one or more visual tokens based on an input image, generating a significance map for the set of visual tokens based on the set of visual tokens and look-twice feature matching (LTFM) using two embeddings, and identifying one or more anomalous visual tokens associated with the input image based on the set of one or more visual tokens associated with the input image and the significance map.

The LTFM may include merging a visual token from the set of visual tokens with a first learnable, positive embedding of the two embeddings. The LTFM may include merging a visual token from the set of visual tokens with a second learnable, negative embedding of the two embeddings. The LTFM may include generating a description by passing the merged visual token through a multi-layer perceptron (MLP). The identifying one or more of the anomalous visual tokens may include element-wise multiplication of a visual token from the set of visual tokens and the significance map.

### BRIEF DESCRIPTION OF THE DRAWINGS

FIG. 1 is an exemplary component diagram of a system for towards zero-shot anomaly detection and reasoning with multimodal large language models (MLLMs), according to one aspect.

FIG. 2 is an exemplary flow diagram of a computer-implemented method for towards zero-shot anomaly detection and reasoning with multimodal large language models (MLLMs), according to one aspect.

FIGS. 3-5 are exemplary diagrams of towards zero-shot anomaly detection and reasoning using a multimodal large language model (MLLM), according to one aspect.

FIG. 6 is an illustration of an example computing environment where one or more of the provisions set forth herein are implemented, according to one aspect.

FIG. 7 is an illustration of an example computer-readable medium or computer-readable device including processor-executable instructions configured to embody one or more of the provisions set forth herein, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “controller”, as used herein, may be a device implemented in hardware, firmware, software, or a combination thereof. A controller may include one or more CPUs (e.g., a central processing unit including one or more “processors”), a “memory”, a “storage drive”, a “bus”, and one or more programmable input/output (I/O) peripherals.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “robot”, as used herein, may be a machine, such as one programmable by a computer, and capable of carrying out a complex series of actions automatically. A robot may be guided by an external control device or the control may be embedded within a controller. It will be appreciated that a robot may be designed to perform a task with no regard to appearance. Therefore, a ‘robot’ may include a machine which does not necessarily resemble a human, including a vehicle, a device, a flying robot, a manipulator, a robotic arm, etc.

A “robot system”, as used herein, may be any automatic or manual systems that may be used to enhance robot performance. Exemplary robot systems include a motor system, an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a suspension system, an audio system, a sensory system, among others.

According to one aspect, Zero-Shot Anomaly Detection (ZSAD) is an emerging Anomaly Detection (AD) paradigm. Unlike the traditional unsupervised AD setting that requires a large number of normal samples to train a model, ZSAD is more practical for handling data-restricted real-world scenarios. Multimodal Large Language Models (MLLMs) have shown revolutionary reasoning capabilities in various vision tasks. However, the reasoning of image abnormalities remains underexplored due to the lack of corresponding datasets and benchmarks. Current MLLMs, such as generative pretrained transformers (GPT) cannot accurately detect and describe fine-grained anomalous details in images. To address this, an Anomaly-OneVision framework is provided herein, which may be useful for assisting with ZSAD and reasoning. The framework is inspired by human behavior in visual inspection, and Anomaly-OneVision leverages a Look-Twice Feature Matching (LTFM) mechanism to adaptively select and emphasize abnormal visual tokens.

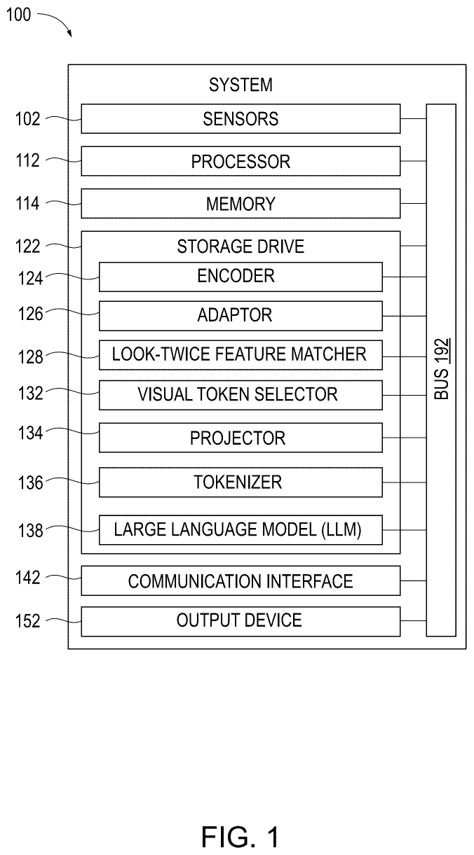

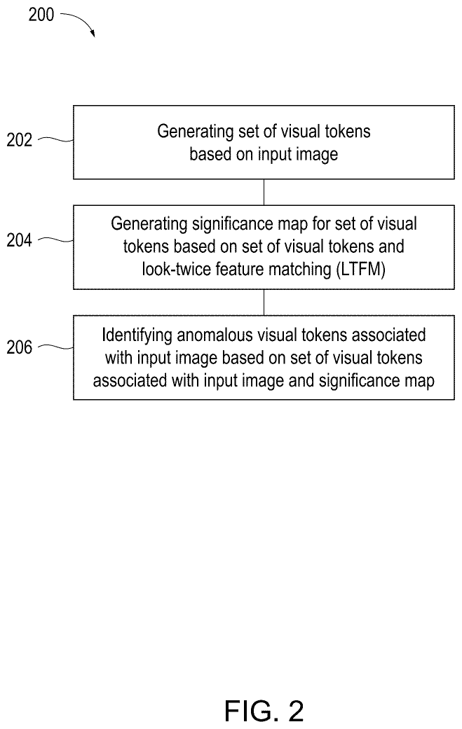

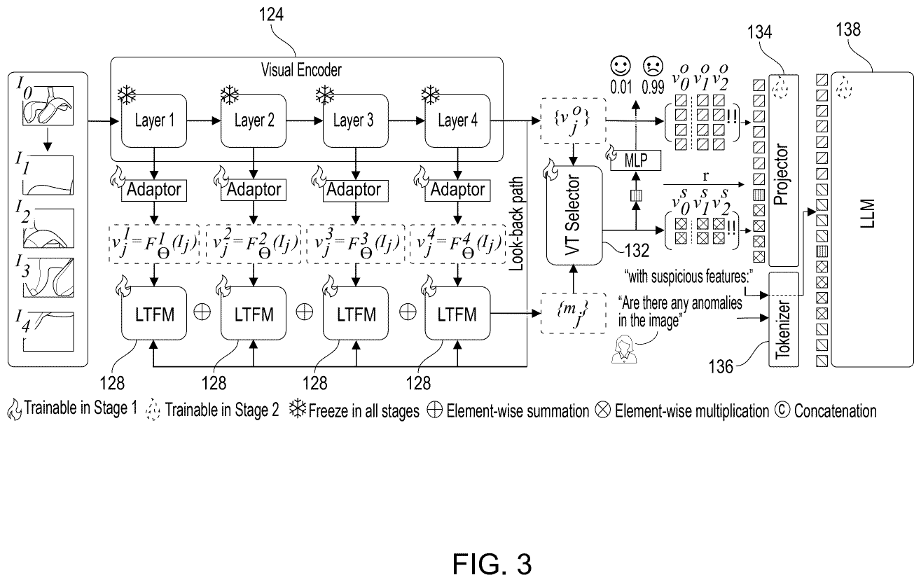

FIG. 1 is an exemplary component diagram of a system 100 for towards zero-shot anomaly detection and reasoning with multimodal large language models (MLLMs) and is described in conjunction with FIGS. 3-5, according to one aspect. FIG. 2 is an exemplary flow diagram of a computer-implemented method for towards zero-shot anomaly detection and reasoning with multimodal large language models (MLLMs), according to one aspect. FIGS. 3-5 are exemplary diagrams of towards zero-shot anomaly detection and reasoning using an MLLM, according to one aspect. FIGS. 3-5 illustrate an overview of the Anomaly-OneVision architecture. The Anomaly-OneVision architecture may include two training stages: (1) professional training for an anomaly expert, and (2) visual instruction tuning for anomaly detection and reasoning. Text tokens and visual tokens are distinguished by different shading or hatching.

The system 100 for towards zero-shot anomaly detection and reasoning with MLLMs may include one or more sensors 102, a processor 112, a memory 114, and a storage drive 122. The storage drive 122 may store an encoder 124, an adapter 126, a look-twice feature matcher (LTFM 128), a visual token (VT) selector 132, a projector 134, a tokenizer 136, and a large language model (LLM). According to one aspect, the communication interface 142 may receive the encoder 124, the adapter 126, the LTFM 128, the VT selector 132, the projector 134, the tokenizer 136, and/or the LLM 138 from an external server (not shown) via a communication interface 142 and communicate the respective information to the storage drive 122 for local storage. The system 100 for towards zero-shot anomaly detection and reasoning with MLLMs may include the communication interface 142, an output device 152, and a bus 192. The bus 192 may form an operable connection between respective components of the system 100 for towards zero-shot anomaly detection and reasoning with MLLMs and enable computer communication therebetween. According to one aspect, one or more of the sensors 102 may receive an input image and may include an image capture device. The memory 114 may store one or more instructions. The processor 112 may execute one or more of the instructions stored on the memory 114 to perform one or more acts, actions, and/or steps.

Multimodal Large Language Models (MLLMs) are artificial intelligence (AI) models that may understand and create content in multiple forms, like text, images, and audio. MLLMs may combine the reasoning abilities of Large Language Models (LLMs) with the ability to process and output multimodal information. Training an MLLM from scratch may demand extensive data and computational resources to align the visual and textual embedding spaces and develop robust instruction-following capabilities. Often, pretrained MLLMs function as generalists, possessing a broad knowledge base but underperforming in specialized domains. Therefore, a goal may be to introduce an auxiliary specialist or expert model designed to guide the generalist in selecting and utilizing visual tokens of relevance. This approach provides the benefit or advantage of mitigating the need for large-scale pre-training while preserving the generalization capacity of the original model.

According to one aspect and by way of example, a LLaVA-OneVision may be used as a base MLLM. However, any MLLM may be utilized as a base MLLM. The LLaVA-OneVision may follow the model architectures for LLaVA family and other generic MLLMs, which may include the visual encoder 124, the projector 134, and the LLM 138. The visual encoder 124 may extract the visual information from the raw input image(s). The projector 134 may align the spaces of visual features or visual tokens with the word embedding.

According to one aspect, visual features may be represented as a set of token sequences and may be visual tokens. The processor 112 may generate a set of one or more visual tokens based on the input image. The generating the set of one or more of the visual tokens may be based on a visual encoder 124 and the input image. The LLM 138 may be responsible for textual instruction processing and complex reasoning. Since the image resolution for Contrastive Language-Image Pretraining (CLIP) may be fixed, LLaVA-OneVision may leverage AnyRes with pooling strategy to scale up the input raw image resolution. Further, the high-resolution images may be divided into a prototyped number of crops, and the visual encoder 124 may independently process the image crops before final spatial pooling.

### Architecture Overview

With the same image-splitting strategy, AnyRes as LLaVA-OneVision, an input high-resolution image may be split into several crops (e.g., image patches) by the processor 112, and the new image crops set may be expressed as:

$$𝒥 = \{ {I}_{0} , {I}_{1} , {I}_{2} , … , {I}_{n - 1} \} \qquad ( 1 )$$

where I₀ is the resized original image and I_{j≠0} may refer to the image crops. As shown in FIGS. 3-5, the image set [symbol] may be processed by the visual encoder 124 [symbol] _{θ} including one or more layers to generate the final visual features

$$\{ {v}_{j}^{o} \} .$$

The processor 112 may store the outputs for one or more selected layers in a Vision Transformer (ViT) to capture the image representations from different levels and apply one or more adapters 126 to compress the feature dimension. Although four layers, adapters 126, etc. are shown in FIG. 3, any number may be implemented. The extracted visual features may be expressed as:

$${v}_{j}^{i} = {ℱ}_{θ}^{i} ( {I}_{j} ) \qquad ( 2 )$$

where i denotes the i-th level and j may refer to the index of corresponding image in [symbol] . These multi-level features are effective in capturing fine-grained local semantics.

The large-scale pre-trained CLIP models may align the projection spaces of the textual and visual encoder 124. Therefore, the encoded image features already include the class information utilized by Zero-Shot Anomaly Detection (ZSAD). To avoid human involvement in object classification and reduce the model complexity, the visual model itself may parse the information for suspicious classes or objects. Further, the output visual features for the original image

$${v}_{0}^{o}$$

may be leveraged to provide the global description of the target object or regions in the look-back path. With the multi-level features and the global embeddings, the LTFM 128 may be responsible for the recognition and localization of suspicious tokens.

Drawing inspiration from human visual inspection, where suspicious objects or regions may be identified and then inspected closely, the VT selector 132 may be designed for aggregating (e.g., zooming in) the visual tokens of interest and explicitly assisting the LLM 138 in distinguishing these tokens from irrelevant visual tokens when dealing with instructions regarding anomaly detection and reasoning. Additionally, the original visual features may be preserved to maintain the generalization capability of the base model on regular instructions, such as “can you describe the content of the image”?

### Look-Twice Feature Matching

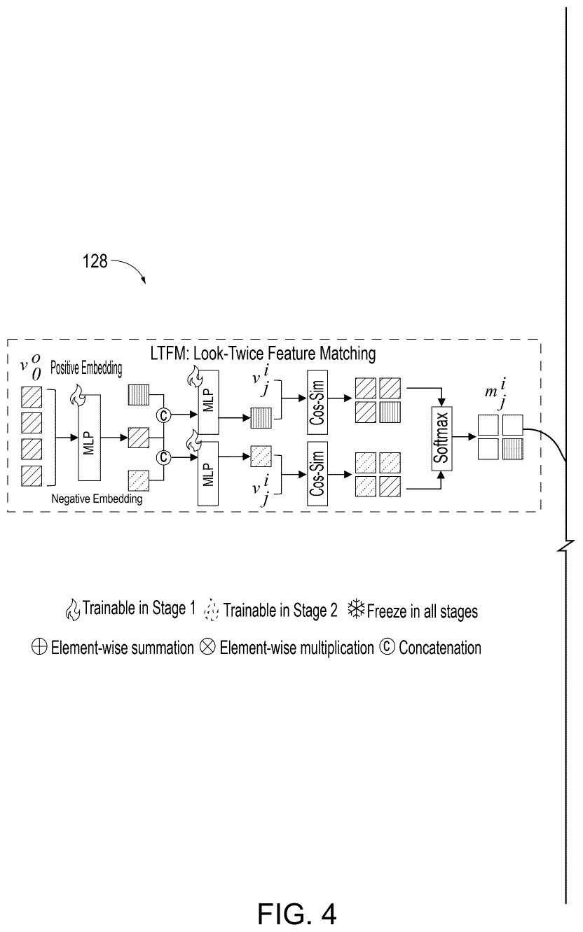

As seen in FIG. 4, the processor 112 may perform generating a significance map for the set of visual tokens based on the set of visual tokens and look-twice feature matching (LTFM). The LTFM 128 may merge a visual token from the set of visual tokens with a first learnable, positive embedding. The LTFM 128 may merge a visual token from the set of visual tokens with a second learnable, negative embedding. The LTFM 128 may generate a description by passing the merged visual token through a multi-layer perceptron (MLP).

Given the global object information

$${v}_{0}^{o}$$

provided by the look-back path, the processor 112 may generate a class-awareness abnormality description by merging

$${v}_{0}^{o}$$

with two learnable embeddings: e⁺∈ [symbol] ^{D} and e⁻∈ [symbol] ^{D}, where + and − indicate positive (e.g., anomalous) and negative (e.g., normal) patterns and D may be the embedding dimension. Specifically, a linear layer

$${𝒯}_{i}^{o}$$

may be applied along the token dimension to select and fuse useful tokens from

$${v}_{0}^{o} ,$$

and then the fused vector may be concatenated with e⁺ and e⁻ independently and passed through two multi-layer perceptron (MLPs)

$$\{ {𝒢}_{i}^{+} , {𝒢}_{i}^{-} \}$$

to generate the abnormality and normality descriptions

$$\{ {d}_{i}^{+} , {d}_{i}^{-} \} ,$$

which may be represented by:

$$\{ {d}_{i}^{+} , {d}_{i}^{-} \} = \{ \begin{matrix}{𝒢}_{i}^{+} ( {e}^{+} ◦ {𝒯}_{i}^{o} ( {v}_{0}^{o} ) ) \\ {𝒢}_{i}^{-} ( {e}^{+} ◦ {𝒯}_{i}^{o} ( {v}_{0}^{o} ) )\end{matrix} \qquad ( 3 )$$

The visual features extracted from different levels of the ViT focus on different scales of semantics. Thus, the parameters of

$${𝒯}_{i}^{o} and \{ {𝒢}_{i}^{+} , {𝒢}_{i}^{-} \}$$

may be independent for different levels, where i may indicate the level number.

Similar to the zero-shot classification mechanism of CLIP models, the processor 112 may calculate the possibilities of each patch token in

$${v}_{j}^{i}$$

belonging to the anomalous patterns by combining cosine similarity and SoftMax operations:

$${m}_{j}^{i} = \frac{exp ( 〈 {d}_{i}^{+} , {v}_{j}^{i} 〉 / τ )}{exp ( 〈 {d}_{i}^{+} , {v}_{j}^{i} 〉 / τ ) + exp ( 〈 {d}_{i}^{-} , {v}_{j}^{i} 〉 / τ )} \qquad ( 4 )$$

where

$${m}_{j}^{i}$$

may represent the significance map for visual tokens, τ may be the temperature hyperparameter, and <, > may refer to a cosine similarity operator. The patch weight in

$${m}_{j}^{i}$$

may indicate the closeness of the corresponding visual token to the anomalous pattern. Then, all the significance maps may be averaged to capture the token significances from low to high levels:

$${m}_{j} = {\sum }_{i - 1}^{4} {m}_{j}^{i} / 4 \qquad ( 5 )$$

According to one aspect, the visual features may be leveraged twice in the forward paths and look-back paths, as with LTFM 128, following the nature of two-step human visual inspection. In this way, look-twice feature matching may be implemented.

### Visual Token (VT) Selector

Under the image cropping strategy widely applied in recent MLLMs, there may be a large number of visual tokens for a high-resolution image. For example, there may be 7290 tokens for an image with 1152×1152 resolution in LLaVA-OneVision. While these tokens provide rich visual details, the LLM 138 may pick the most useful information when adapting to a specific task. When the LLM 138 lacks enough knowledge in this domain, the token-picking process may become complicated. Thus, the solution may be to introduce a specialist or expert who knows which token is useful or of interest or not and assist the LLM 138 in selecting and emphasizing (e.g., zooming in) the visual tokens of interest.

Given the encoded visual tokens

$$\{ {v}_{j}^{o} \}$$

for each image crop in [symbol] and the corresponding significance map mⱼ, the suspicious tokens may be emphasized by direct multiplication of the two tensors (e.g., significance map m; and encoded visual tokens

$$\{ {v}_{j}^{o} \}$$

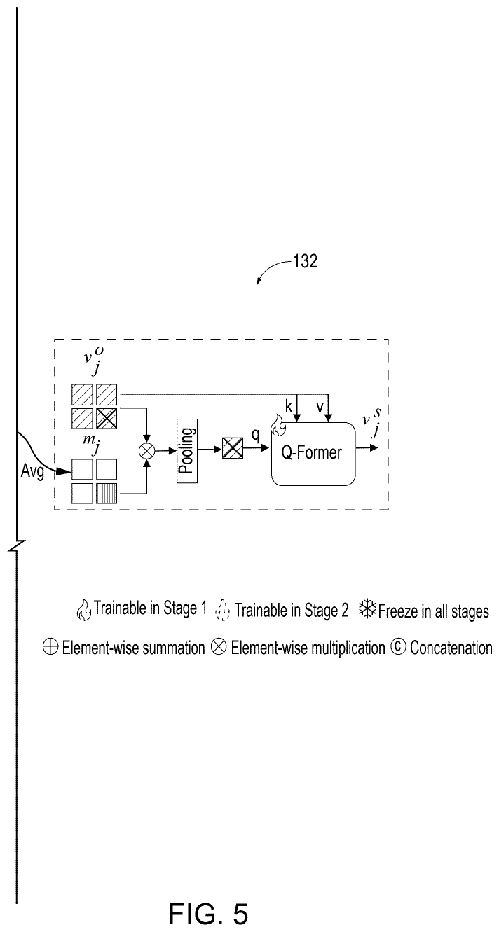

as seen in FIG. 5. Then, the normal tokens may be scaled to zero while the anomalous tokens are maintained. After that, spatial average pooling [symbol] may be applied to reduce the number of tokens. This process may be expressed as:

$${q}_{j} = 𝒫 ( {v}_{j}^{o} ⊙ {m}_{j} ) \qquad ( 6 )$$

where qⱼ∈ [symbol] ^{h×w×D} refers to the pooled query tokens. Empirically, setting h=w=2 may provide a better trade-off than other options. Then, a Q-Former [symbol] may be leveraged to aggregate the correlated tokens in the original output by forwarding qⱼ as the query and

$${v}_{j}^{o}$$

as the key and value:

$${v}_{j}^{s} = ( {q}_{j} , {v}_{j}^{o} , {v}_{j}^{o} ) \qquad ( 7 )$$

The VT selector 132 may serve as a tool for the anomaly expert to hand-pick visual tokens that contain the most suspicious semantics for a given image.

### Inference and Loss-Anomaly Prediction

In an anomaly detection task, the model may predict the possibility of the image being abnormal. To achieve anomaly score prediction, the processor 112 may aggregate the anomaly information from all the image crops by an average operation weighted on the significance maps:

$$r ( 𝒥 ) = \frac{{\sum }_{j , k} {v}_{j}^{s} [ k ] \cdot 𝒫 ( {m}_{j} ) [ k ]}{{\sum }_{j , k} 𝒫 ( {m}_{j} ) [ k ]} \qquad ( 8 )$$

where [symbol] is the same spatial pooling in the VT selector 132 and r( [symbol] ) may be a vector containing the global anomaly information for the entire image. Then, the anomaly expert may calculate the image-level abnormal possibility by parsing r( [symbol] ):

$$score ( 𝒥 ) = Sigmoid ( {𝒢}^{o} ( r ( 𝒥 ) ) ) \qquad ( 9 )$$

where [symbol] ^{o} may be an MLP for distinguishing normal and abnormal semantics. To handle the unbalanced sample distribution, the processor 112 may employ the balanced Binary Cross Entropy (BCE) loss as the professional training objective for the anomaly expert components.

### Inference and Loss-Text Generation

The processor 112 may perform identifying one or more anomalous visual tokens associated with the input image based on the set of one or more visual tokens associated with the input image and the significance map. The identifying one or more anomalous visual tokens may be based on the LLM 138. The identifying one or more anomalous visual tokens may include generating a first input for the LLM 138 based on a projector 134 and one or more of the anomalous visual tokens. The identifying one or more anomalous visual tokens may include generating a second input for the LLM 138 based on a tokenizer 136 and a query. The identifying one or more of the anomalous visual tokens may include element-wise multiplication of a visual token from the set of visual tokens and the significance map. The identifying one or more of the anomalous visual tokens may include applying spatial average pooling.

Rather than directly forwarding the concatenation of the original

$$\{ {v}_{j}^{o} \}$$

and the selected

$$\{ r ( 𝒥 ) , {v}_{j}^{s} \}$$

visual tokens into the LLM 138, the processor 112 may apply an indication prompt with <adv> suspicious feature: in the middle of the two series of tokens, which may highlight the selected tokens for the LLM 138 when handling anomaly-related instructions. This approach may be considered a form of prompt engineering in MLLMs. Besides, the <adv> is chosen from {highly, moderately, slightly} and may be determined by score ( [symbol] ) and predefined thresholds {s_{low}, s_{high}}. When the input image [symbol] has a high likelihood of anomaly, the LLM 138 may place greater emphasis on the selected tokens; otherwise, these tokens may have less significance. The text generation may be implemented by the original auto-regressive token prediction mechanism of LLM:

$$p ( {X}_{a} \vert 𝒥 , {X}_{q} ) = {\prod }_{t = 1}^{L} {p}_{θ} ( {x}_{t} \vert {X}_{q , < t} , {X}_{a , < t} ) \qquad ( 10 )$$

where X_{a,<t} and X_{q,<t} are the answer and instruction tokens from all prior turns before the current prediction token xₜ for a sequence of length L. The entire model may be parameterized by θ and trained by the original language model cross-entropy loss for each predicted answer token xₜ.

The output device 152 may include a mobile device, a speaker, a display device, etc. and may output, display, or play an indication of one or more of the anomalous visual tokens or suspicious visual tokens, or an output of the LLM 138 indicating the anomalous visual tokens or suspicious visual tokens. According to one aspect, the output device 152 may be implemented as a robot and may include one or more robot systems.

FIG. 2 is an exemplary flow diagram of a computer-implemented method 200 for towards zero-shot anomaly detection and reasoning with multimodal large language models (MLLMs), according to one aspect. The computer-implemented method 200 for towards zero-shot anomaly detection and reasoning with MLLMs may include generating 202 a set of one or more visual tokens based on an input image, generating 204 a significance map for the set of visual tokens based on the set of visual tokens and look-twice feature matching (LTFM), and identifying 206 one or more anomalous visual tokens associated with the input image based on the set of one or more visual tokens associated with the input image and the significance map.

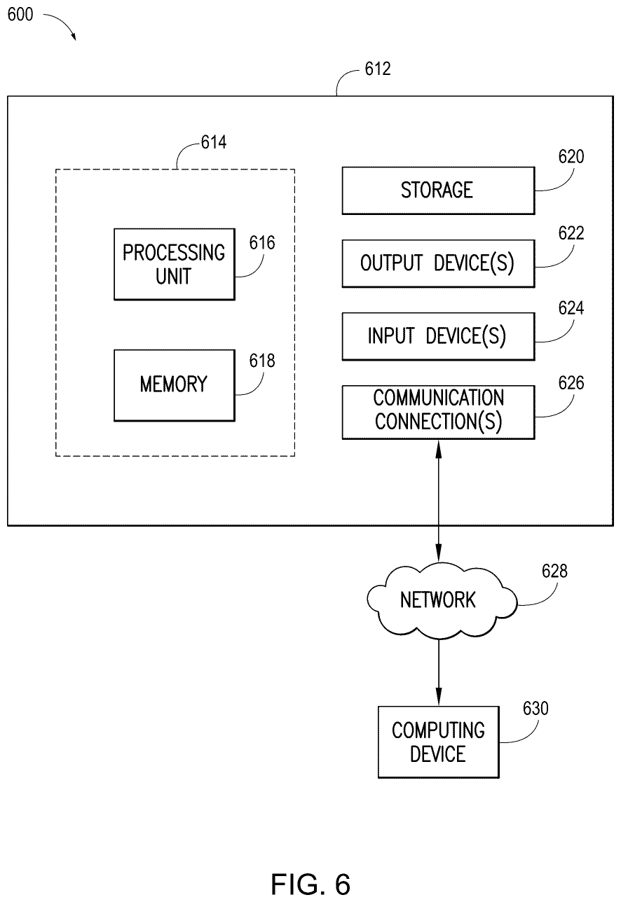

FIG. 6 and the following discussion provide a description of a suitable computing environment to implement aspects of one or more of the provisions set forth herein. The operating environment of FIG. 6 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, which perform one or more tasks or implement one or more abstract data types. Typically, the functionality of the computer readable instructions are combined or distributed as desired in various environments.

FIG. 6 illustrates a system 600 including a computing device 612 configured to implement one aspect provided herein. In one configuration, the computing device 612 includes at least one processing unit 616 and memory 618. Depending on the exact configuration and type of computing device, memory 618 may be volatile, such as RAM, non-volatile, such as ROM, flash memory, etc., or a combination of the two. This configuration is illustrated in FIG. 6 by dashed line 614.

In other aspects, the computing device 612 includes additional features or functionality. For example, the computing device 612 may include additional storage such as removable storage or non-removable storage, including, but not limited to, magnetic storage, optical storage, etc. Such additional storage is illustrated in FIG. 6 by storage 620. In one aspect, computer readable instructions to implement one aspect provided herein are in storage 620. Storage 620 may store other computer readable instructions to implement an operating system, an application program, etc. Computer readable instructions may be loaded in memory 618 for execution by the at least one processing unit 616, for example.

The term “computer readable media” as used herein includes computer storage media. Computer storage media includes volatile and nonvolatile, removable, and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 612. Any such computer storage media is part of the computing device 612.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 612 includes input device(s) 624 such as keyboard, mouse, pen, voice input device, touch input device, infrared cameras, video input devices, or any other input device. Output device(s) 622 such as one or more displays, speakers, printers, or any other output device may be included with the computing device 612. Input device(s) 624 and output device(s) 622 may be connected to the computing device 612 via a wired connection, wireless connection, or any combination thereof. In one aspect, an input device or an output device from another computing device may be used as input device(s) 624 or output device(s) 622 for the computing device 612. The computing device 612 may include communication connection(s) 626 to facilitate communications with one or more other devices 630, such as through network 628, for example.

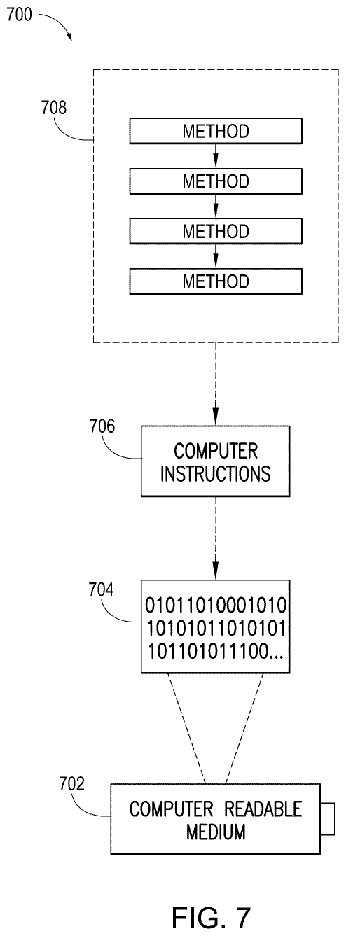

Still another aspect involves a computer-readable medium including processor-executable instructions configured to implement one aspect of the techniques presented herein. An aspect of a computer-readable medium or a computer-readable device devised in these ways is illustrated in FIG. 7, wherein an implementation 700 includes a computer-readable medium 702, such as a CD-R, DVD-R, flash drive, a platter of a hard disk drive, etc., on which is encoded computer-readable data 704. This encoded computer-readable data 704, such as binary data including a plurality of zero's and one's as shown in 704, in turn includes a set of processor-executable computer instructions 706 configured to operate according to one or more of the principles set forth herein. In this implementation 700, the processor-executable computer instructions 706 may be configured to perform a method 708, such as the computer-implemented method 200 for towards zero-shot anomaly detection and reasoning with multimodal large language models (MLLMs) of FIG. 2. In another aspect, the processor-executable computer instructions 706 may be configured to implement a system, such as the system for towards zero-shot anomaly detection and reasoning with MLLMs of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for towards zero-shot anomaly detection and reasoning with multimodal large language models (MLLMs), comprising:
a memory storing one or more instructions; and
a processor executing one or more of the instructions stored on the memory to perform:
generating a set of one or more visual tokens based on an input image;
generating a significance map for the set of visual tokens based on the set of visual tokens and look-twice feature matching (LTFM); and
identifying one or more anomalous visual tokens associated with the input image based on the set of one or more visual tokens associated with the input image and the significance map.

2. The system for towards zero-shot anomaly detection and reasoning with MLLMs of claim 1, wherein the identifying one or more anomalous visual tokens is based on a large language model (LLM).

3. The system for towards zero-shot anomaly detection and reasoning with MLLMs of claim 2, wherein the identifying one or more anomalous visual tokens includes generating a first input for the LLM based on a projector and one or more of the anomalous visual tokens.

4. The system for towards zero-shot anomaly detection and reasoning with MLLMs of claim 3, wherein the identifying one or more anomalous visual tokens includes generating a second input for the LLM based on a tokenizer and a query.

5. The system for towards zero-shot anomaly detection and reasoning with MLLMs of claim 1, wherein the generating the set of one or more of the visual tokens is based on a visual encoder and the input image.

6. The system for towards zero-shot anomaly detection and reasoning with MLLMs of claim 1, wherein the LTFM includes merging a visual token from the set of visual tokens with a first learnable, positive embedding.

7. The system for towards zero-shot anomaly detection and reasoning with MLLMs of claim 1, wherein the LTFM includes merging a visual token from the set of visual tokens with a second learnable, negative embedding.

8. The system for towards zero-shot anomaly detection and reasoning with MLLMs of claim 7, wherein the LTFM includes generating a description by passing the merged visual token through a multi-layer perceptron (MLP).

9. The system for towards zero-shot anomaly detection and reasoning with MLLMs of claim 1, wherein the identifying one or more of the anomalous visual tokens includes element-wise multiplication of a visual token from the set of visual tokens and the significance map.

10. The system for towards zero-shot anomaly detection and reasoning with MLLMs of claim 1, wherein the identifying one or more of the anomalous visual tokens includes applying spatial average pooling.

11. A computer-implemented method for towards zero-shot anomaly detection and reasoning with multimodal large language models (MLLMs), comprising:
generating a set of one or more visual tokens based on an input image;
generating a significance map for the set of visual tokens based on the set of visual tokens and look-twice feature matching (LTFM); and
identifying one or more anomalous visual tokens associated with the input image based on the set of one or more visual tokens associated with the input image and the significance map.

12. The computer-implemented method for towards zero-shot anomaly detection and reasoning with MLLMs of claim 11, wherein the identifying one or more anomalous visual tokens is based on a large language model (LLM).

13. The computer-implemented method for towards zero-shot anomaly detection and reasoning with MLLMs of claim 12, wherein the identifying one or more anomalous visual tokens includes generating a first input for the LLM based on a projector and one or more of the anomalous visual tokens.

14. The computer-implemented method for towards zero-shot anomaly detection and reasoning with MLLMs of claim 13, wherein the identifying one or more anomalous visual tokens includes generating a second input for the LLM based on a tokenizer and a query.

15. The computer-implemented method for towards zero-shot anomaly detection and reasoning with MLLMs of claim 11, wherein the generating the set of one or more of the visual tokens is based on a visual encoder and the input image.

16. A system for towards zero-shot anomaly detection and reasoning with multimodal large language models (MLLMs), comprising:
a memory storing one or more instructions; and
a processor executing one or more of the instructions stored on the memory to perform:
generating a set of one or more visual tokens based on an input image;
generating a significance map for the set of visual tokens based on the set of visual tokens and look-twice feature matching (LTFM) using two embeddings; and
identifying one or more anomalous visual tokens associated with the input image based on the set of one or more visual tokens associated with the input image and the significance map.

17. The system for towards zero-shot anomaly detection and reasoning with MLLMs of claim 16, wherein the LTFM includes merging a visual token from the set of visual tokens with a first learnable, positive embedding of the two embeddings.

18. The system for towards zero-shot anomaly detection and reasoning with MLLMs of claim 16, wherein the LTFM includes merging a visual token from the set of visual tokens with a second learnable, negative embedding of the two embeddings.

19. The system for towards zero-shot anomaly detection and reasoning with MLLMs of claim 17, wherein the LTFM includes generating a description by passing the merged visual token through a multi-layer perceptron (MLP).

20. The system for towards zero-shot anomaly detection and reasoning with MLLMs of claim 16, wherein the identifying one or more of the anomalous visual tokens includes element-wise multiplication of a visual token from the set of visual tokens and the significance map.
